(19) United States
(12) Patent Application Publication
(10) Pub. No.: US 2008/0278063 A1
(43) Pub. Date: Nov. 13, 2008

(54) ELECTROLUMINESCENT DEVICE HAVING IMPROVED POWER DISTRIBUTION

(76) Inventor: Ronald S. Cok, Rochester, NY (US)

Correspondence Address: David Novais;Patent Legal Staff, Eastman Kodak Company, 343 State Steet, Rochester, NY, 14650-2201, US

(21) Appl. No.: 11/744,950

(22) Filed: May 7, 2007

(51) Int. Cl. H01J 1/62

(52) U.S. Cl. 313/500; 313/498; 313/506

(57) ABSTRACT

An electroluminescent device comprising a first electrode and a second electrode having an EL unit formed there-between, wherein the EL unit comprises a light-emitting layer containing quantum dots, and the first and second electrodes define one or more light-emitting areas; wherein at least a portion of the second electrode is transparent and light emitted by the EL unit is viewed from a first side of the electroluminescent device that is nearer the second electrode; and one or more reflective elements that are electrically-conductive and are formed as part of the second electrode or in electrical communication with the second electrode; and wherein the reflective elements are located at least partially within the light emitting areas.

### FIELD OF THE INVENTION

The present invention relates to electroluminescent devices; and, more particularly, to electroluminescent device structures for improving light output, contrast and power distribution.

### BACKGROUND OF THE INVENTION

Semiconductor light emitting diode (LED) devices, which are primarily inorganic, have been made since the early 1960's and currently are manufactured for use in a wide range of consumer and commercial applications. The layers comprising the LEDs are based on crystalline semiconductor materials. These crystalline-based inorganic LEDs have the advantages of high brightness, long lifetimes, and good environmental stability. The crystalline semiconductor layers that provide these advantages also have a number of disadvantages. The dominant ones are high manufacturing costs; difficulty in combining multi-color output from the same chip; efficiency of light output; and the need for high-cost rigid substrates.

In the mid 1980's, organic light-emitting diodes (OLEDs) based on small molecular weight molecules were invented (Tang et al, Applied Physics Letter 51, 913 (1987)). In the early 1990's, polymeric LEDs were invented (Burroughs et al., Nature 347, 539 (1990)). In the ensuing 15 years, organic-based LED displays have been brought out into the marketplace and there have been great improvements in device lifetime, efficiency, and brightness. For example, devices containing phosphorescent emitters have external quantum efficiencies as high as 19%; whereas, device lifetimes are routinely reported at many tens of thousands of hours. However, in comparison to crystalline-based inorganic LEDs, OLEDs suffer reduced brightness, shorter lifetimes, and require expensive encapsulation for device operation.

To improve the performance of OLEDs, in the late 1990's OLED devices containing mixed emitters of organics and quantum dots were introduced (Mattoussi et al., Journal of Applied Physics 83, 7965 (1998)). Quantum dots are light-emitting nano-sized semiconductor crystals. Adding quantum dots to the emitter layers could enhance the color gamut of the device; red, green, and blue emission could be obtained by simply varying the quantum dot particle size; and the manufacturing cost could be reduced. Because of problems such as aggregation of the quantum dots in the emitter layer, the efficiency of these devices was rather low in comparison with typical OLED devices. The efficiency was even poorer when a neat film of quantum dots was used as the emitter layer (Hikmet et al., Journal of Applied Physics 93, 3509 (2003)). The poor efficiency was attributed to the insulating nature of the quantum-dot layer. Later the efficiency was boosted (to ˜1.5 cd/A) upon depositing a mono-layer film of quantum dots between organic hole and electron transport layers (Coe et al., Nature 420, 800 (2002)). It was stated that luminescence from the quantum dots occurred mainly as a result of Forster energy transfer from excitons on the organic molecules (electron-hole recombination occurs on the organic molecules). Regardless of improvements in efficiency, these hybrid devices still suffer from all of the drawbacks associated with pure OLED devices.

Recently, a mainly all-inorganic LED was constructed (Mueller et al., Nano Letters 5, 1039 (2005)) by sandwiching a monolayer thick core/shell CdSe/ZnS quantum-dot layer between vacuum deposited inorganic n- and p-GaN layers. The resulting device had a poor external quantum efficiency of 0.001 to 0.01%. Part of that problem could be associated with the organic ligands of trioctylphosphine oxide (TOPO) and trioctylphosphine (TOP) that were reported to be present post growth. These organic ligands are insulators and would result in poor electron and hole injection into the quantum dots. In addition, the remainder of the structure is costly to manufacture, due to the usage of electron and hole semiconducting layers grown by high-vacuum techniques, and the usage of sapphire substrates.

As described in co-pending, commonly assigned U.S. Ser. No. 11/226,622 by Kahen, which is hereby incorporated by reference in its entirety, additional semiconductor nanoparticles may be provided with the quantum dots in a layer to enhance the conductivity of the light-emitting layer.

Both inorganic and hybrid inorganic-organic light-emitting diodes (LEDs) are electroluminescent technologies that rely upon thin-film layers of materials coated upon a substrate. These technologies typically employ a cover affixed to the substrate around the periphery of the LED device to protect the device from physical harm. The thin-film layers of materials can include, for example, organic materials, quantum dots, fused inorganic nano-particles, electrodes, conductors, and silicon electronic components as are known and taught in the LED art. The cover may include a cavity to avoid contacting the cover to the thin-film layers of materials when the cover is affixed to the substrate. Alternatively, it is known to provide a polymer layer between the thin-film layers of materials and the cover.

Quantum dot light-emitting diode structures may be employed to form flat-panel displays and area illumination lamps. Likewise, colored-light or white-light lighting applications are of interest. Different materials may be employed to emit different colors and the materials may be patterned over a surface to form full-color pixels. In various embodiments, the quantum dot LEDs may be electronically or photonically stimulated and may be mixed or blended with a light-emitting organic host material for hybrid inorganic-organic LEDs.

Electroluminescent devices containing quantum dot light-emitting diode (LED) structures are a promising technology for flat-panel displays and area illumination lamps and backlights. Applications of electroluminescent devices include active-matrix image displays, passive-matrix image displays, and area-lighting devices such as, for example, selective desktop lighting. Irrespective of the particular electroluminescent device configuration tailored to these broad fields of applications, all electroluminescent devices function on the same general principles. An electroluminescent (EL) unit is sandwiched between two electrodes. At least one of the electrodes is at least partially light transmissive. These electrodes are commonly referred to as an anode and a cathode in analogy to the terminals of a conventional diode. When an electrical potential is applied between the electrodes so that the anode is connected to the positive terminal of a voltage source and the cathode is connected to the negative terminal, the LED is said to be forward-biased. Positive charge carriers (holes) are injected from the anode into the EL unit, and negative charge carriers (electrons) are injected from the cathode. Such charge carrier injection causes current flow from the electrodes through the EL unit. Recombination of holes and electrons within the core of a quantum dot in the light-emitting layer of the EL unit results in emission of light. A hybrid inorganic-organic EL unit can be formed of a stack of sublayers that can include small-molecule layers or polymer layers. Such organic layers and sublayers are well known and understood by those skilled in the OLED art.

Light generated from the EL device is emitted through the glass substrate. This is commonly referred to as a bottom-emitting device. Alternatively, a device can include a substrate, a reflective anode, a stack of organic layers, and a top transparent cathode layer. Light generated from the device is emitted through the top transparent electrode. This is commonly referred to as a top-emitting device. In typical hybrid LED devices, the refractive indices of the ITO layer, the organic semiconductor layers, and the glass are about 2.0, 1.7, and 1.5 respectively. It has been estimated that nearly 60% of the generated light is trapped by internal reflection in the ITO/organic EL element, 20% is trapped in the glass substrate, and only about 20% of the generated light is actually emitted from the device and performs useful functions. For all-inorganic devices, the situation is worse due to the higher refractive index of the EL unit—typically greater than or equal to 2.0.

Full-color electroluminescent devices may employ a variety of materials to emit different colors of light. In this arrangement, the electroluminescent device is patterned with different sets of materials, each set of materials associated with a particular color of light emitted. Each pixel in an active-matrix full-color electroluminescent device typically employs each set of organic materials, for example to form a red, green, and blue sub-pixel. In an alternative arrangement, a single set of materials emitting broadband light may be deposited in continuous layers with arrays of differently colored filters employed to create a full-color electroluminescent device. In addition, black-matrix materials may be employed between the color filters in non-emissive areas of the electroluminescent device to absorb ambient light and thereby improve the contrast of the electroluminescent device. Such color filter and black-matrix materials are known in the art and are employed, for example, in the LCD industry. The contrast improvement possible by providing a black-matrix material between light-emitting areas of electroluminescent device is limited by the relative size of the light-emitting areas and the areas between the light-emitting areas, i.e. the fill factor of the electroluminescent device.

The emitted light is directed towards an observer, or towards an object to be illuminated, through the light transmissive electrode. If the light transmissive electrode is between the substrate and the light emissive elements of the electroluminescent device, the device is called a bottom-emitting electroluminescent device. Conversely, if the light transmissive electrode is not between the substrate and the light emissive elements, the device is referred to as a top-emitting electroluminescent device.

In top-emitting electroluminescent devices, light is emitted through an upper electrode or top electrode, typically but not necessarily the cathode, which has to be sufficiently light transmissive, while the lower electrode(s) or bottom electrode(s), typically, but not necessarily the anode, can be made of relatively thick and electrically conductive metal compositions which can be optically opaque. Because light is emitted through a top electrode, it is important that the top electrode through which light is emitted be sufficiently light transmissive to avoid absorbing the emitted light. Typical prior-art materials proposed for such top electrodes include indium tin oxide (ITO) and very thin layers of metal, for example silver or aluminum or metal alloys including silver or aluminum. However, the current carrying capacity of such electrodes is limited, thereby limiting the amount of power that can be supplied to the LED materials, and hence the amount of light that can be emitted from the EL unit.

In both top and bottom emitting electroluminescent devices, power can be supplied to the electrodes either directly through electricity-carrying busses or through thin-film electronic components powered by such busses. Since the current necessary to drive the LED is supplied through the busses, any limitation in the conductivity, capacitance, or inductance of the busses will limit the light emission and switching speed of the pixels.

The LED materials emit light in proportion to the density of current passed through them. One way known in the art to reduce the current density is to increase the size of the light-emitting area, sometimes known as the aperture ratio or fill factor. However, the maximum fill factor is limited by the presence of conductive busses and thin-film electronic components, particularly for bottom-emitting devices.

Referring to FIGS. 3 and 4, a bottom-emitting OLED known in the prior art is illustrated having a transparent substrate 10. Over the substrate 10, a semiconducting layer is formed providing thin-film electronic components 30 for driving an OLED. Components 30 are connected to current and signal distribution busses 19. An interlayer insulating and planarizing layer 32 is formed over the thin-film electronic components 30 and busses 19, and a patterned transparent electrode 16 defining OLED light-emissive areas 51 is formed over the insulating layer 32. An inter-pixel insulating film 34 separates the elements of the patterned transparent electrode 16. EL unit 14, containing one or more first layers of organic material, one of which emits light, is formed over the patterned transparent electrode 12. A reflective second electrode 12 is formed over the EL unit 14. A gap separates the reflective second electrode 12 from an encapsulating cover 21. The encapsulating cover 21 may be coated directly over the reflective electrode 12 so that no gap exists. The thin-film electronic components 30 are driven by current and signal distribution busses 19 provided between light emissive areas 51 to conduct electrical power and signals from external device controllers (not shown) to the electrodes 12 and 16. However, since busses 19 are positioned between light emissive areas 51, the size and conductivity of busses 19 is limited by the desired aperture ratio of the emissive area, limiting the amount of current and switching rate of the OLED device.

Referring to FIG. 4, a top view of a simplistic, prior-art layout on a substrate 10 includes an emissive area 51, thin-film electronic components 30 for driving the electrodes, and signal and current busses 19 for providing power and signals to the thin-film electronic components 30. The relative sizes and spacing of the various elements in the device is typically defined by the requirements of the manufacturing process; this example is illustrative only and presumes that the resolution and spacing requirements of the various components is constant. The manufacturing process may define, for example, the resolution and spacing of the light-emitting area 51, the busses 19, and the size of the thin-film electrical components 30. If the size of the busses 19 is increased, thereby improving the signal and power distribution in the device, the size of the light-emitting areas 51 is decreased, thereby increasing the current density of the driving currents in the OLED (at a constant brightness) and reducing the lifetime of the materials. If the size of the light-emitting areas 51 is increased, thereby decreasing the current density of the driving currents in the OLED (at a constant brightness) and increasing the lifetime of the materials, the remaining area for the busses 19 is decreased, thereby reducing the effectiveness of the signal and power distribution in the device.

Referring to FIG. 5, a top-emitting electroluminescent device as suggested by the prior art is illustrated having a substrate 10 (either reflective, transparent, or opaque). Over the substrate 10, a semiconducting layer is formed providing thin-film electronic components 30 for driving an LED. An interlayer insulating and planarizing layer 32 is formed over the thin-film electronic components 30 and a patterned reflective electrode 12 defining OLED light-emissive elements is formed over the insulating layer 32. An inter-pixel insulating film 34 separates the elements of the patterned reflective electrode 12. One or more first layers 14 of material, one of which emits light, are formed over the patterned reflective electrode 12. A transparent second electrode 16 is formed over the one or more first layers 14 of organic material. A gap 38 separates the transparent second electrode 16 from an encapsulating cover 21. The encapsulating cover 21 is transparent and may be coated directly over the transparent electrode 16 so that no gap 38 exists. In some prior-art embodiments, the first electrode 12 may instead be at least partially transparent and/or light absorbing. Because suitable transparent conductors, for example ITO, have a limited conductivity, the current that may be passed through the organic layers 14 is limited and the uniformity of the light-emitting areas in an electroluminescent device may be adversely affected by differences in current passed through various portions of the transparent conductor 16. As taught in U.S. Pat. No. 6,812,637 entitled, “OLED Display with Auxiliary Electrode” issued to Cok, an auxiliary electrode 70 may be provided between the light-emitting areas of the OLED to improve the conductivity of the transparent electrode and enhance the current distribution in the OLED. For example, a thick, patterned layer of aluminum or silver or other metals or metal alloys may be employed. However, the thick patterned layer of metal may not be transparent, requiring the auxiliary electrode 70 to be located between the light-emitting areas, limiting its conductivity and restricting the manufacturing tolerances of the OLED, thereby increasing costs. Likewise, a typical black matrix supplied over the OLED device is similarly limited to locations between the light-emitting areas, reducing the contrast of the OLED device.

In commercial OLED practice, the substrate and cover have comprised 0.7 mm thick glass. For relatively small devices, for example, less than five inches in diagonal, the use of a cavity in an encapsulating cover 21 is an effective means of providing relatively rigid protection to the thin-film layers of materials 12, 14, 16. However, for very large devices, the substrate 10 or cover 21, even when composed of rigid materials like glass and employing materials in the gap 38, can bend slightly and cause the inside of the encapsulating cover 21 or materials in the gap 38 to contact or press upon the thin-film layers of materials 12, 14, 16, possibly damaging them and reducing the utility of the OLED device.

It is known to employ spacer elements to separate thin sheets of materials. For example, U.S. Pat. No. 6,259,204 entitled, “Organic electroluminescent device” describes the use of spacers to control the height of a sealing sheet above a substrate. Such an application does not, however, provide protection to thin-film layers of materials in an OLED device. US 2004/0027327 entitled, “Components and methods for use in electro-optic displays” published Feb. 12, 2004 describes the use of spacer beads introduced between a backplane and a front plane laminate to prevent extrusion of a sealing material when laminating the backplane to the front plane of a flexible display. However, in this design, any thin-film layers of materials are not protected when the cover is stressed. Moreover, the sealing material will reduce the transparency of the device and requires additional manufacturing steps.

U.S. Pat. No. 6,821,828 entitled, “Method of manufacturing a semiconductor device” issued Nov. 23, 2004, describes an organic resin film such as an acrylic resin film patterned to form columnar spacers in desired positions in order to keep two substrates apart. The gap between the substrates is filled with liquid crystal materials. The columnar spacers may be replaced by spherical spacers sprayed onto the entire surface of the substrate. However, columnar spacers are formed lithographically and require complex processing steps and expensive materials. Moreover, this design is applied to liquid crystal devices and does not provide protection to thin-film structures deposited on a substrate.

U.S. Pat. No. 6,551,440 entitled, “Method of manufacturing color electroluminescent display apparatus and method of bonding light-transmitting substrates” issued Apr. 22, 2003 describes use of a spacer of a predetermined grain diameter interposed between substrates to maintain a predetermined distance between the substrates. When a sealing resin deposited between the substrates spreads, surface tension draws the substrates together. The substrates are prevented from being in absolute contact by interposing the spacer between the substrates, so that the resin can be smoothly spread between the substrates. This design does not provide protection to thin-film structures deposited on a substrate.

A prior-art top-emitter OLED device as illustrated in FIG. 4 typically uses a glass substrate, a reflective conducting first electrode 12 comprising a metal, for example aluminum or silver, a stack of organic layers, and transparent conducting second electrode 16 employing, for example, indium-tin-oxide (ITO). Light generated from the device is emitted through the transparent electrode 16. In these conventional devices, the index of the ITO layers, the organic layers, and the glass is about 2.0, 1.7, and 1.5 respectively. It has been estimated that nearly 50% of the generated light is trapped by internal reflection in the ITO/organic EL element, 25% is trapped in the glass substrate, and only about 25% of the generated light is actually emitted from the device and performs useful functions.

A variety of techniques have been proposed to improve the out-coupling of light from thin-film light emitting devices. For example, Chou (International Publication Number WO 02/37580 A1) and Liu et al. (U.S. Patent Application Publication No. 2001/0026124) teach the use of a volume or surface scattering layer to improve light extraction. The scattering layer is applied next to the organic layers or on the outside surface of the glass substrate and has an optical index that matches these layers. Light emitted from the LED device that would have otherwise been trapped can penetrate into the scattering layer and be scattered out of the device. The efficiency of the LED device is improved, but trapped light may propagate a considerable distance horizontally through the cover, substrate, or layers in the EL unit before being scattered out of the device, thereby reducing the sharpness of the device in pixellated applications such as displays.

There is a need, therefore, for an improved electroluminescent device structure that improves the power distribution over the electroluminescent device; and within light-emissive areas of the electroluminescent device, improves contrast, light output, and sharpness of the electroluminescent device.

### SUMMARY OF THE INVENTION

In accordance with one embodiment, the invention is directed towards an electroluminescent device, comprising:

a first electrode and a second electrode defining one or more light-emitting areas, and having an EL unit formed there-between, wherein the EL unit comprises a light-emitting layer; wherein at least a portion of the second electrode is transparent and transmits light from the electroluminescent device from a first side of the second electrode opposite a second side of the second electrode that is adjacent to the EL unit and

one or more reflective elements that are electrically-conductive and are formed as part of the second electrode or are in electrical communication with the second electrode; and wherein the reflective elements are located at least partially within the one or more light emitting areas.

### ADVANTAGES

Various embodiments of the present invention have improved power distribution over the electroluminescent device; and, within light-emissive areas of the electroluminescent device, improved contrast, light output, and sharpness of an electroluminescent device.

### BRIEF DESCRIPTION OF THE DRAWINGS

FIG. 1 is a partial cross section of a top-emitter device according to an embodiment of the present invention;

FIG. 2 is a cross section of a LED device;

FIG. 3 is a partial cross section of a prior art bottom-emitter device;

FIG. 4 is a top view of a prior-art bottom-emitter device;

FIG. 5 is a cross section of a top-emitter device having an auxiliary electrode as described in the prior art;

FIG. 6 is a partial cross section of a bottom-emitter device according to an embodiment of the present invention;

FIGS. 7a and 7b are partial cross sections of top-emitter devices with two different bi-layer electrodes according to alternative embodiments of the present invention;

FIG. 8 illustrates the path of light rays within a partial cross section of a top-emitter device according to an embodiment of the present invention;

FIG. 9 is a top-view of a bi-layer electrode according to an embodiment of the present invention;

FIG. 10 is a partial cross section of a top-emitter device having a scattering layer according to yet another embodiment of the present invention;

FIG. 11 is a cross section of a top-emitter device having an auxiliary electrode and a scattering layer according to an alternative embodiment of the present invention;

FIG. 12 is a cross section of a top-emitter device having an auxiliary electrode and a scattering layer above a transparent layer according to an embodiment of the present invention;

FIG. 13 is a partial cross section of a top-emitter device having an auxiliary electrode and color filters according to another embodiment of the present invention;

FIG. 14 is a partial cross section of an active matrix bottom-emitter device according to an embodiment of the present invention;

FIG. 15 is a top-view of a bottom-emitter device layout according to an embodiment of the present invention;

FIG. 16 is a top-view of a bottom-emitter device layout according to an alternative embodiment of the present invention;

FIG. 17 is a top-view of a bottom-emitter device layout according to another embodiment of the present invention;

FIG. 18a is a partial cross section of a bottom-emitter device illustrating the path of light rays according to an embodiment of the present invention;

FIG. 18b is a partial cross section of a top-emitter device illustrating the path of light rays according to another embodiment of the present invention;

FIG. 19 is a partial cross section of a bottom-emitter device incorporating a scattering layer according to an embodiment of the present invention;

FIG. 20 is a partial cross section of a bottom-emitter device incorporating a scattering reflective electrically-conductive bus according to an alternative embodiment of the present invention;

FIG. 21 is a cross section of a top-emitter device with a cover according to one embodiment of the present invention;

FIG. 22 is a cross section of a top-emitter device with a cover according to another alternative embodiment of the present invention;

FIG. 23 shows a schematic of a light emitting core/shell quantum dot; and

FIG. 24 shows a schematic of a section of a polycrystalline inorganic light-emitting layer in accordance with the invention.

It will be understood that the figures are not to scale since the individual layers are too thin and the thickness differences of various layers too great to permit depiction to scale.

### DETAILED DESCRIPTION OF THE INVENTION

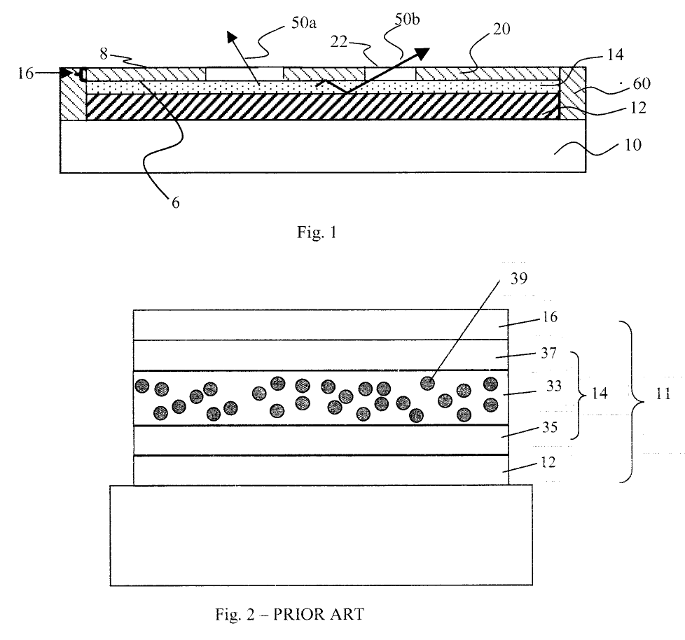

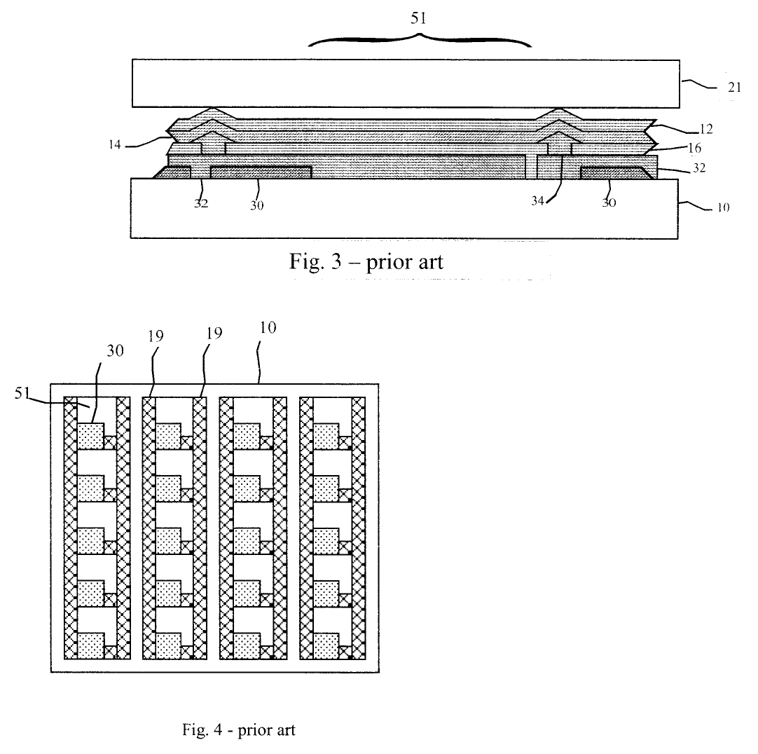

Referring to FIG. 1, in one top-emitting embodiment of the present invention, an electroluminescent device comprises first and second electrodes 12 and 16 having an EL unit 14 formed there-between, at least one layer in the EL unit being a light-emitting layer containing quantum dots, and the coextensive conductive areas of the first and second electrodes 12 and 16 defining one or more light-emissive areas. In the illustrated embodiment, electrode 16 comprises reflective elements 20 and transparent portions 22 in the light emissive area. The transparent portion 22 of the second electrode 16 is typically a relatively lower electrically conductive portion and light 50a emitted by the light-emitting organic layer passes through the transparent portion 22; the reflective portion 20 is typically a relatively higher electrically conductive portion and reflects emitted light 50b. The second electrode 16 can also be said to have two sides, a first side 6 adjacent to the EL unit 14 and a second side 8. As illustrated in FIG. 1, light that leaves the electroluminescent device, light 50a and 50b, exits the second side 8 of second electrode 16 through the transparent portion 22. Either the first or second electrodes 12 or 16 may be formed on a substrate 10. Reflective edges 60 may be employed to prevent light escaping from the light-emitting area defined by the first and second electrodes 12 and 16. Electrode 16 includes at least one relatively more reflective element 20 located in the light-emissive area such that a transparent portion 22 is formed in the light-emissive area between the at least one reflective portion 20 and an edge of the light emissive area, so that current distribution may be improved within the light-emissive area.

EL unit 14 can be better understood from examination of FIG. 2. A typical LED structure 11 is shown to contain an electroluminescent (EL) unit 14 between a first electrode 12 and second electrode 16. The EL unit 14 as illustrated contains all layers between the first electrode 12 and the second electrode 16, but not the electrodes themselves. The light-emitting layer 33 can contain any material that emits light by the recombination of holes and electrons. In a preferred embodiment, light-emitting layer 33 contains light-emitting quantum dots 39 in a semiconductor matrix 31. Quantum dots 39 as defined in this disclosure are light-emitting nanoparticles. As illustrated in FIG. 2, the quantum dots 39 can be spherical, but should not be limited to this shape. Light-emitting quantum dots can have any shape, including spheres, rods and wires, so long as they are inorganic crystalline nanoparticles that exhibit quantum confinement effects. Semiconductor matrix 31 can be an organic host material in the case of hybrid devices, or a polycrystalline inorganic semiconductor matrix in the case of inorganic quantum dot LEDs. EL unit 14 can optionally contain p-type or n-type charge transport layers 35 and 37, respectively, in order to improve charge injection. EL unit 14 can have additional charge transport layers, or contact layers (not shown). One typical LED device uses a glass substrate, a transparent conducting anode such as indium-tin-oxide (ITO), an EL unit 14 containing a stack of layers, and a reflective cathode layer. The layers in the EL unit 14 can be organic, inorganic, or a combination thereof.

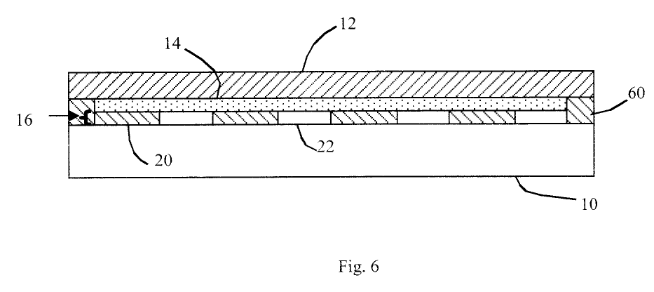

In the top-emitting embodiment of FIG. 1, electrode 12 is located between the substrate 10 and the EL unit 14 and light is emitted from the LED through an encapsulating cover (not shown). Referring to FIG. 6, a bottom-emitting embodiment of the present invention locates electrode 16 between the substrate 10 and the EL unit 14 and light is emitted from the LED through the substrate 10. In FIGS. 1 and 6, electrode 16 is patterned and formed in a single layer with distinct transparent portions 22 and reflective elements 20 and may be formed through patterned material deposition, for example, by evaporation or sputtering through a mask. Alternatively, patterned portions may be formed by patterned removal of material, e.g., by photolithography. The reflective elements 20 may comprise metal (for example, silver, aluminum, or magnesium) or metal alloys while the transparent materials may comprise metal oxides, for example, indium tin oxide. These materials are well known, as are patterned deposition and removal techniques.

The transparent portions 22 of electrode 16 may be any shape or size and may include multiple non-contiguous transparent areas, for example rectangular or circular holes through which light may be emitted by the EL unit 14. By transparent it is meant that light of the desired frequency may pass through. The transparent portions 22 of the present invention can include filters, for example, color or neutral density filters, according to the present invention, the transparent portions 22 preferably transmit a greater portion of the emitted light than the reflective elements 20 of electrode 16. Likewise, the reflective elements 20 preferably reflect a greater portion of the emitted light than the transparent portions 22 of electrode 16. Preferably, the transparent portions 22 are equal to or greater than 1 micron in at least one dimension to facilitate light transmission through the transparent portions 22 for frequencies of light less than 1 micron in wavelength. In general, it is preferred that a plurality of separated transparent portions 22 be provided so that emitted light passing through the transparent portion 22 is not significantly absorbed by repeated passages through layer(s) 14 before it reaches the transparent portion 22.

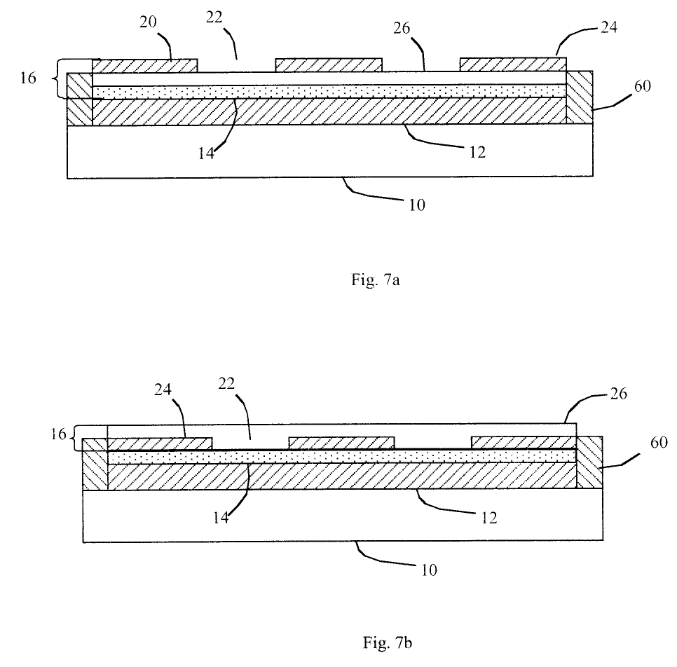

Referring to FIG. 7a, in an alternative embodiment of the present invention, electrode 16 comprises two layers. The first layer is a transparent conductive layer 26 formed adjacent to the EL unit 14 and the second layer is a patterned reflective conductive layer 24 formed and patterned over the transparent conductive layer 26. The coextensive areas of patterned reflective conductive layer 24 and transparent conductive layer 26 define the reflective elements 20 of electrode 16. This arrangement has the advantage of not requiring patterned deposition of the transparent portion 22 of electrode 16. The transparent conductive layer 26 is preferably continuous so as to provide current to all portions of the organic layers 14. The reflective conductive layer 24 need not be continuous and may preferably be discontinuous to enhance patterning in the manufacturing process. Referring to FIG. 7b, the reflective conductive layer 24 may be patterned and deposited first and the transparent conductive layer 26 may be deposited over the entire surface, including the back of the reflective conductive layer 24.

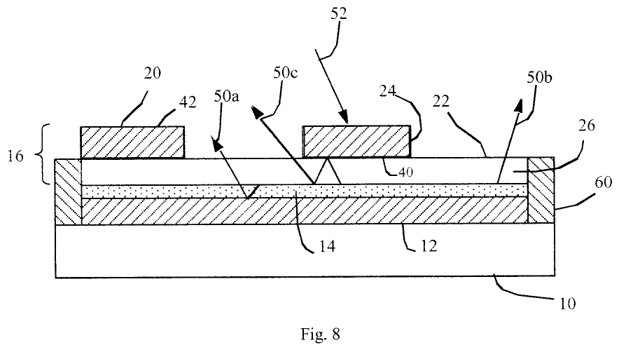

Referring to FIG. 8, in various embodiments of the present invention, the patterned conductive layer 24 defining reflective elements 20 of electrode 16 may have two sides, one side being reflective and having a reflective surface 40 for reflecting emitted light and a second side being light-absorbing and having a light absorbing surface 42 for absorbing ambient light. The reflective surface 40 faces toward the light-emitting EL unit 14 and reflects emitted light. The light-absorbing surface 42 faces toward a view of the OLED device and is exposed to ambient light. By forming a light-absorbing surface on the reflective elements 20, ambient light is absorbed and the contrast of the OLED device is increased. The contrast is limited by the percentage of electrode's 16 area that is light absorbing compared to the transparent portion 22. As the transparent portion 22 is reduced, the contrast is increased. Since the present invention employs an auxiliary electrode in the light emissive area, it increases the percentage of area that may be coated by light-absorbing materials, and improves contrast for an OLED device. Suitable materials that may be coated on patterned conductive layer 24 for absorbing light to provide a light-absorbing surface 42 can include, for example, a metal oxide, metal sulfide, silicon oxide, silicon nitride, carbon, a light-absorbing polymer, a polymer doped with an absorbing dye, or combinations thereof. Preferably, the light-absorbing material is black, e.g., carbon black and can include additional anti-reflective coatings.

Again referring to the LED structure in FIG. 8 and its operation, current is supplied through electrodes 12 and 16. The current flows through the layers of the EL unit 14 causing the quantum dots to emit light. Light 50a emitted toward the electrode 12 is reflected. Light 50b emitted toward the transparent portion 22 is directly emitted. Light 50c emitted toward the reflective elements 20 is reflected toward electrode 12 and alternately encounters the reflective elements 20 and the electrode 12, until the light is emitted through a transparent portion 22 and escapes from the LED. Because electrode 12 is reflective in this embodiment, light emitted beneath the reflective elements 20 is not lost, but eventually escapes from the LED. Hence, although in practice some emitted light may be absorbed by the layers in the EL unit 14, the electrode 12 and reflective elements 20, the present invention will emit nearly the same amount of light as a conventional LED design, while employing a smaller emissive area.

As shown in FIG. 8, ambient light 52 incident upon an OLED device of the illustrated embodiment of the present invention may be absorbed by the light-absorbing surface 42 of the patterned layer 24. Alternatively, the ambient light may pass through a transparent portion 22 and eventually be re-emitted from the LED device as unwanted, reflected light.

The physical limit of the contrast improvement possible according to various embodiments of the present invention will be limited by the actual light absorption of the EL unit 14 in the LED and by losses due to imperfect reflection by the reflective electrode 12 or the reflective elements 20 of electrode 16. These absorptions and imperfect reflections will also reduce the amount of emitted light that passes out of the LED device. According to one embodiment of the present invention, the light-absorbing surface 42 of patterned reflective layer 24 will improve the ambient contrast of the OLED device in direct proportion to the light-absorbing area percentage of the electrode 16.

In any practical implementation of a useful LED device, there must be at least one transparent portion 22 for each light-emitting area in the OLED device. Hence, the minimum number of openings and the maximum spacing of the transparent portions 22 are defined by the LED device configuration. In general, it is useful to have several transparent portions 22 per light-emitting area or pixel. The size and shape of the transparent portions 22 are not critical and may be determined by practical limitations in the manufacture of the LED device. Since light may be absorbed by the EL unit 14 or imperfectly reflected from the reflective electrode 12 or reflective element 20, it is preferred that many holes be provided for each light-emitting area. For example, in an OED device having a plurality of light-emitting areas defined by a patterned electrode of 50 microns by 200 microns, it may be preferred to provide 5 micron-diameter holes on 20-micron centers to provide an approximately 20% black-matrix fill factor. Such relative light-emitting area and transparent hole sizes will enable electrode 16 to include reflective elements 20 located in the light-emissive area such that a transparent portion 22 is formed in the light-emissive area between the at least one reflective element 20 and the edge of the light-emissive areas, so that current distribution may be improved within the light-emissive area. Alternatively, it may be preferred to provide 3 micron-diameter holes on 12-micron centers to provide a similar black-matrix fill factor. The more frequently spaced openings may decrease the light absorption in the LED device.

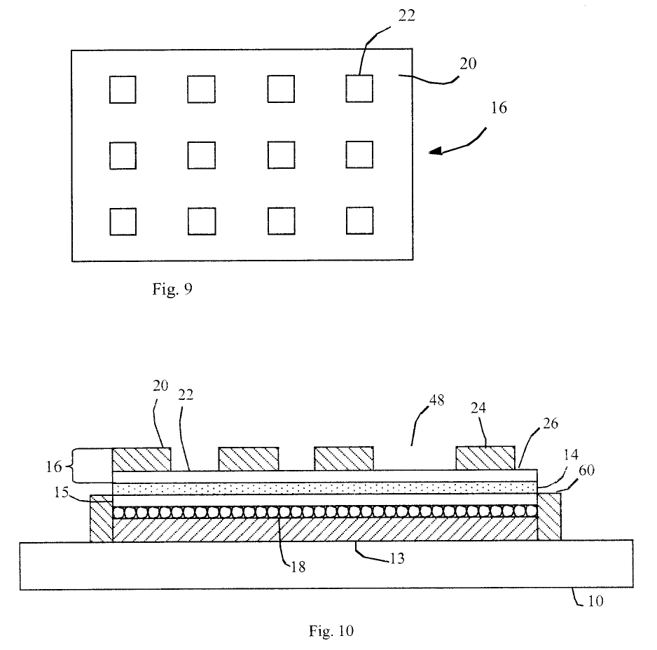

FIG. 9 illustrates a top view of electrode 16 for an electroluminescent device according to various embodiments of the present invention. The transparent portions 22 may be formed, for example, as columns or rows extending the length of the light-emitting area of the LED, as a rectangle (as shown), or as circles and may be formed in a regular array or randomly. The distribution of the transparent openings 22 over the surface may be different in different dimensions. Essentially, any shape or distribution of transparent openings 22 may be employed. As shown in FIG. 10, the transparent openings 22 may be irregular and/or not regularly aligned with the light-emissive areas and may be located in different positions over different light-emissive areas. Alternatively, as shown in FIG. 11, the reflective elements 20 may be regularly patterned, and cover, e.g., the non-light-emitting areas, a contiguous portion of the edges of the light-emitting areas defined by the patterned second electrode, and a portion of the light-emissive area located between the edges of the light-emissive area. Patterning of the more conductive reflective elements 20 may be designed so that current distribution may be optimized and made more uniform within the light-emissive area.

According to the present invention, the reflective element 20 or layer 24 is more conductive than the transparent portion 22 and may comprise a metal, for example, silver, aluminum, magnesium, or metal alloys. The more conductive material will distribute current through the second electrode 16 much more efficiently than the less conductive transparent portions 22 (typically made of metal oxides such as ITO). Alternatively, the transparent and reflective portions may be made of the same material, for example, aluminum or silver or other metals or metal alloys, but the transparent portion 22 may be much thinner (for example, less than 100 nm thick and hence largely transparent) than the thicker, reflective portion 20. Since the present invention increases the percentage of area that may be coated by more conductive materials (for example, metal coatings greater than 100 nm thick and preferably more than 400 nm and more preferably 1 micron), it provides an LED device having improved power distribution. In particular, the reflective element 20 of the electrode 16 may be thicker than the transparent portion 22.

Referring again to FIGS. 10 and 11, in alternative further embodiments of the present invention, a scattering layer 18 may be optically integrated with the electrodes 12 and 16 respectively and the EL unit 14. As described in co-pending, commonly assigned U.S. Ser. No. 11/065,082, filed Feb. 24, 2005, the disclosure of which is hereby incorporated by reference, light emitted by the organic layers of an OLED may be trapped within the OLED device and a light-scattering layer may be employed to scatter the trapped light out of the OLED device. As employed herein, a light-scattering layer 18 is an optical layer that tends to randomly redirect any light that impinges on the layer from any direction. Optically integrated means that light emitted by the EL unit 14 of the current invention encounters the scattering layer 18 before traveling through other layers having an optical index lower than those of the EL unit or electrodes.

The scattering layer 18 may be formed only in the areas where the transparent portions 22 are located or, alternatively, may be located over the entire light-emitting area or only in areas where the reflective elements 20 are located. The scattering layer 18 may be formed, for example, as shown in FIGS. 10 and 11, between a transparent conductive layer 15 and a reflective layer 13. The transparent conductive layer 15 is formed between the scattering layer 18 and the EL unit 14. Light either emitted or reflected toward the reflective layer 13 will be scattered. In this way, light that normally waveguides between the electrodes through the transparent electrode materials and the EL unit 14 is scattered into a direction that may allow the waveguided light to escape through a transparent portion 22 and escape from the LED device, thereby increasing the light output of the LED device. Alternatively, a reflective electrode 12 having a rough surface that randomly redirects light incident upon it or incorporating light refracting particles may be employed as a scattering layer.

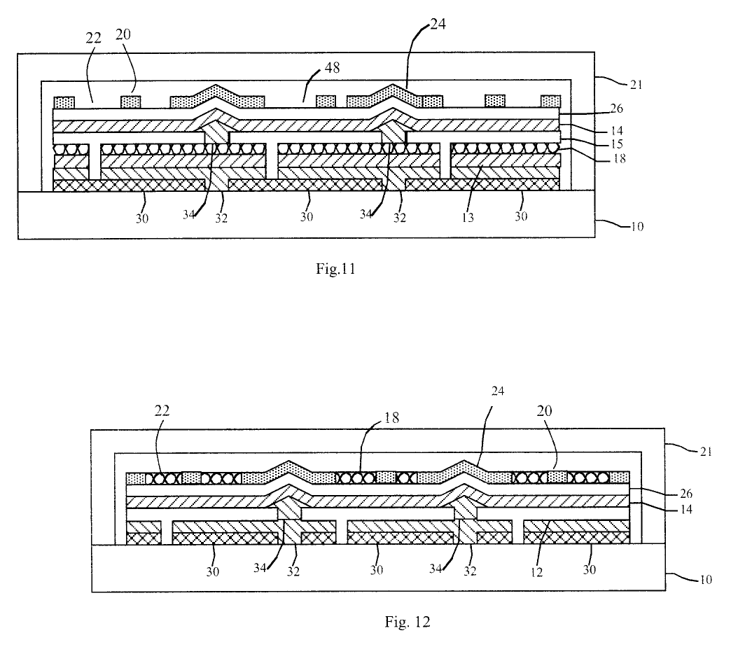

Referring to FIG. 12, in an alternative embodiment of the present invention, a light-scattering layer 18 may be formed in, above, or beneath the transparent portions 22. In this arrangement, the scattering particles may also be formed over the reflective elements 20, as necessary to enable ease of manufacturing, since subsequent layers do not then have to be formed over the irregular surface of a scattering layer.

Scattered light, when directed into a thick layer, may travel a significant distance by total internal reflection in a pixilated device, thereby reducing the sharpness of such a device. In a further embodiment of the invention, the reflective elements 20 of electrode 16 are preferably thicker than the transparent portions 22, providing spacing between the transparent portion and the cover or substrate through which light is emitted. By providing a low-index element 48 having an optical index lower than the index of the EL unit 14 or any cover 21 or substrate 10, in the spaces formed by differences in height between the reflective elements 20 and the transparent portions 22, any light that escapes from the EL unit 14 and the electrodes 12 and 16, and passes through the low-index element 48 before entering any other layer cannot be totally internally reflected in the other layers, thereby increasing the sharpness of the LED device. In particular, if a low-index element 48 (as shown in FIG. 10) is provided between the EL unit 14, electrodes 12 and 16, and light-scattering layer 18 and the substrate or cover, light cannot be totally internally reflected within the substrate 10 or cover 21, thereby enhancing the sharpness of the LED device. Referring to FIGS. 10 and 11, the spaces between the reflective layer 24 through which light escapes may be filled with a low-index element 48, for example, a gas such as air, nitrogen, or argon. Preferably, the difference in height between reflective elements 20 and transparent portions 22 is at least one micron, so that visible light may effectively transmit through the low-index element.

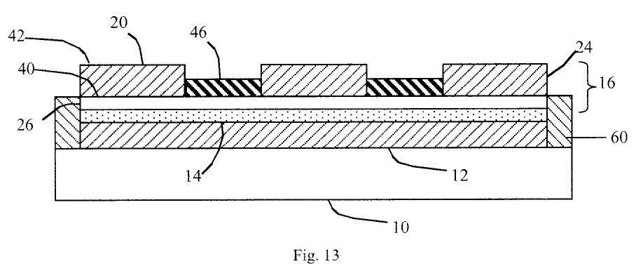

Referring to FIG. 13, in further embodiments of the present invention, a color filter 46 may be aligned with and located in or above the transparent portion 22 to filter the light output from the LED device. The EL unit 14 may either emit a colored light or a broadband light (primarily white in color) and the color filter may be employed to provide an appropriate color of light, for example, to provide a full-color electroluminescent display. In various embodiments, the color filter 46 may be located on the LED above or below a scattering layer, or formed on the cover or substrate of a top-emitting or bottom-emitting electroluminescent device, respectively. Color filters are known in the art and may include, for example, pigments or dyes formed in or on a base material, for example, various protective layers such as glass, silicon or silicon-based materials, polymers, or metal oxides. Neutral density filters may also be employed.

Alternatively, a color filter may be located over the entire extent of the electrode 16. The color filter 46 may be formed on a scattering layer, if present, or on a transparent electrode or any protective or encapsulating layers formed on a transparent electrode or formed on the cover or substrate of a top-emitting or bottom-emitting OLED device, respectively. In this case, both emitted and ambient light that is reflected within the LED device may pass through the filter multiple times.

The scattering layer 18 should be in optical contact with the light emitters in order to effectively enhance the light output of the electroluminescent device. By optical contact is meant that there are no intervening layers having an optical index lower than the optical index of any of the organic and transparent electrode layers and that light that passes through any one of the layers will encounter the scattering layer.

Although LED structures have been primarily described with a cathode on the top and an anode on the bottom near the substrate, it is well known that the EL unit can be inverted and the positions of the anode and cathode exchanged. Both such structures are included in the present invention.

Various conductive and scattering materials useful in the present invention, as well as the employment of light-scattering layers for extracting additional light from the device are further described in co-pending, commonly assigned U.S. Ser. No. 11/065,082, filed Feb. 24, 2005, herein incorporated by reference in its entirety. Additional layers may be usefully employed with the present invention. For example, one problem that may be encountered with scattering layers is that the electrodes may tend to fail to operate at sharp edges associated with the scattering elements in the scattering layer. Although the scattering layer may be planarized, typically such planarizing operations do not form a perfectly smooth, defect-free surface. To reduce the possibility of shorts between the transparent electrodes, a short-reduction layer may be employed over a scattering layer.

Most hybrid inorganic-organic LED devices are sensitive to moisture or oxygen, or both, so they are commonly sealed in an inert atmosphere such as nitrogen or argon, along with a desiccant such as alumina, bauxite, calcium sulfate, clays, silica gel, zeolites, alkaline metal oxides, alkaline earth metal oxides, sulfates, or metal halides and perchlorates. Methods for encapsulation and desiccation include, but are not limited to, those described in U.S. Pat. No. 6,226,890 issued May 8, 2001 to Boroson et al. In addition, barrier layers such as SiOₓ (x>1), Teflon, and alternating inorganic/polymeric layers are known in the art for encapsulation. Atomic layer deposition may be employed to provide encapsulation, for example as described in copending, commonly assigned U.S. Ser. No. 11/122,295, filed Apr. 5, 2005, the disclosure of which is herein incorporated by reference. These encapsulation layers may be formed over the transparent electrode either under or over any of the scattering layers or color filter layers. For example, a protective layer, an encapsulating layer formed by atomic layer deposition and/or a layer of parylene, may be formed over electrode 16.

The present invention may also be employed with four-sub-pixel display designs; for example, a red, green, blue, and white emitter. A neutral density filter may be located over any of the emitters, but in particular may be employed with a white emitter to improve device contrast. Such color or neutral density filters may be located in any of the transparent openings taught herein.

Electroluminescent devices of this invention can employ various well-known optical effects in order to enhance their properties if desired. This includes optimizing layer thicknesses to yield maximum light transmission, providing dielectric mirror structures, replacing reflective electrodes with light-absorbing electrodes, providing anti-glare or anti-reflection coatings over the display, providing a polarizing medium over the display, or providing colored, neutral density, or color conversion filters over the display. Filters, polarizers, and anti-glare or anti-reflection coatings may be specifically provided over the cover or as part of the cover.

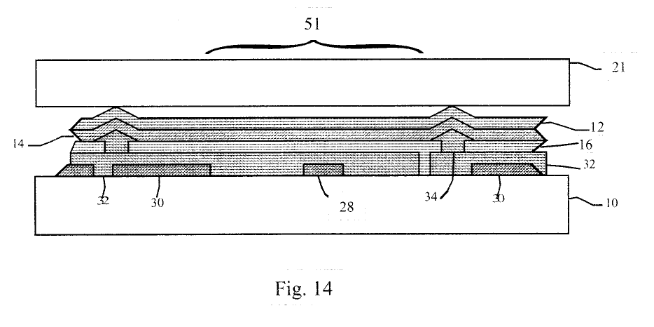

The present invention may be practiced with either active- or passive-matrix electroluminescent devices. It may also be employed in display devices or in area illumination devices. As described in co-pending, commonly assigned U.S. Ser. No. 11/226,622 by Kahen, which is hereby incorporated by reference in its entirety, quantum dots may be employed to form an inorganic EL unit 14. Referring to FIG. 14, in another bottom-emitting embodiment of the present invention, the first and second electrodes 12 and 16 define one or more light-emissive areas 51, and electrode 16 containing transparent portions. A transparent insulator layer 32 is formed adjacent to the electrode 16 opposite the EL unit 14; and reflective elements 20 formed in a layer adjacent to the transparent insulator layer 32 opposite the transparent electrode 16, wherein the reflective elements 20 are a reflective, electrically-conductive bus 28 which comprises a reflective surface directed towards the light-emitting layer and covers only a portion of the light-emissive area 51. The transparent insulating layer 32 may also be a planarization layer.

The electroluminescent device is formed over a substrate 10. A semiconducting layer is formed providing thin-film electronic components 30 for driving the LED. The interlayer insulating and planarizing layer 32 is formed over the thin-film electronic components 30 and the patterned electrode 16, defining light-emissive areas 51, is formed over the transparent insulating layer 32. An inter-pixel insulating film 34 separates the elements of the patterned electrode 16. A gap may separate the second electrode 12 from an encapsulating cover 21. Alternatively, the encapsulating cover 21 may be coated directly over the electrode 12, so that no gap exists.

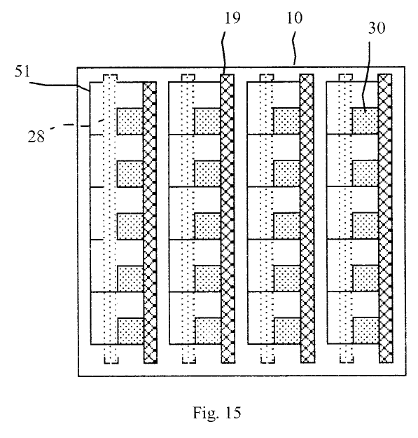

Referring to FIG. 15 in a top view of an embodiment of the present invention, the thin-film electronic components 30 are driven by current and signal distribution busses 19 and a reflective, electrically-conductive bus 28 covering only a portion of the light-emissive area 51. According to the present invention, the total light-emissive area 51, defined by patterned electrode 12, including both the transmissive portions 22 and the reflective elements 20, is larger than would otherwise be the case, if busses 19 and 28 were both formed between light-emissive areas 51, thereby reducing the driving current density in the EL unit in a light-emissive area 51. As shown in FIG. 15, the reflective, electrically-conductive bus 28 covers only a portion of the light-emitting area 51, so that light may be emitted from the remaining portion of the light-emitting area on either side of the reflective, electrically-conductive bus 28.

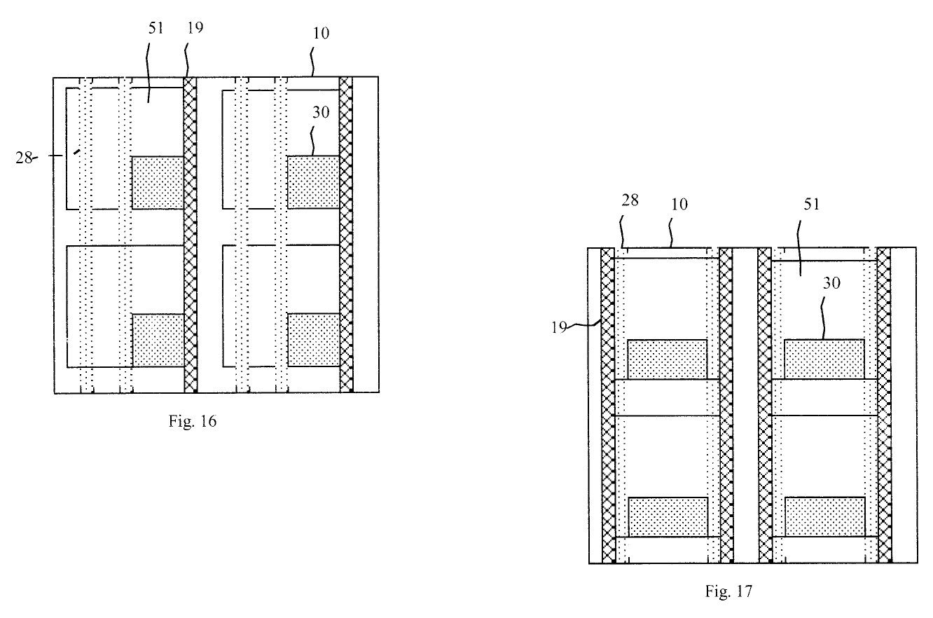

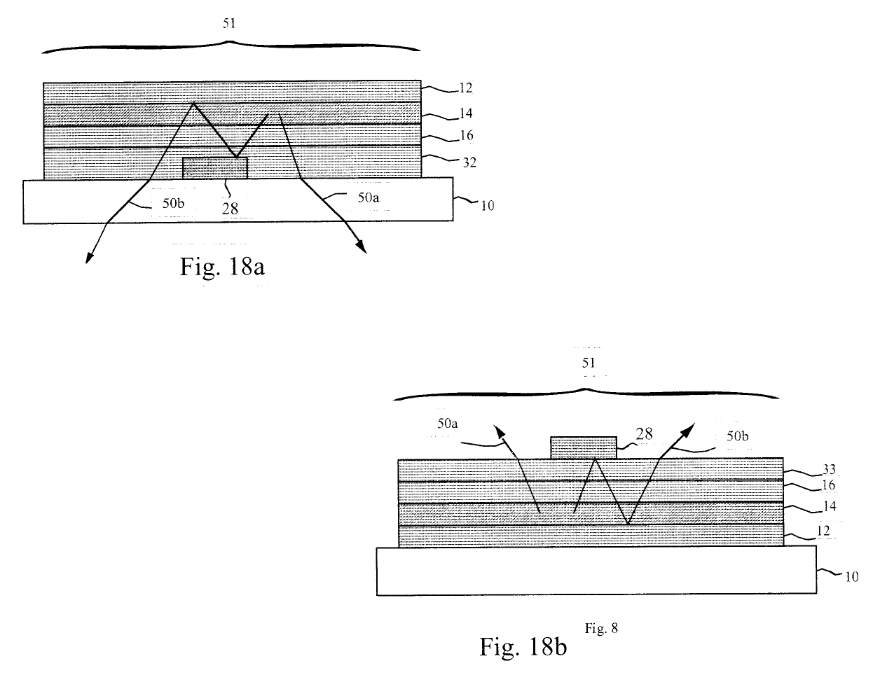

According to various embodiments of the present invention, the reflective, electrically-conductive bus 28 may be positioned in a variety of locations, comprise any of a variety of reflective, conductive materials (e.g., silver, aluminum, magnesium or other metals or metal alloys) as discussed above in for the general description of the reflective elements. In particular, referring to FIG. 16, one or more reflective, electrically-conductive busses 28 may be employed in various embodiments of the present invention and may carry a variety of signals, for example power, data, or select signals as are known in the flat-panel display art. As illustrated in FIGS. 15 and 16, busses 28 can be positioned such that portions of the light emissive area 51 not covered by the reflective electrically-conductive bus are located on more than one side of the reflective, electrically-conductive bus. Referring to FIG. 17, the reflective, electrically-conductive busses 28 may alternatively be located at the edge of the light-emitting area 51 and may be only partially over the light-emitting area 51. In this arrangement, a bus 19 is essentially contiguous with a reflective electrically-conductive bus 18 and electrically connected to it. In other embodiments (not shown), a bus 19 may be partially contiguous with a reflective electrically-conductive bus 18 over a portion of its length. According to other various embodiments of the present invention, the reflective, electrically-conductive busses 18 may be formed in a common step and/or comprise common materials as other busses 19 employed in the OLED device, thereby reducing mask steps and manufacturing costs.

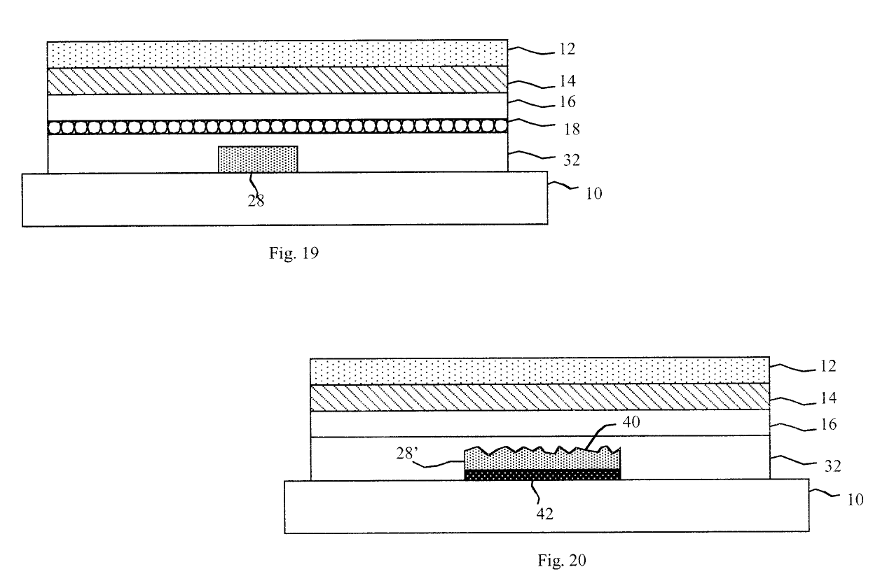

Upon the provision of signals and power through the busses 28 and 19, the thin-film electrical components 30 apply a voltage-differential across the electrodes 12 and 16, causing a current to flow through the EL unit 14 and light to be emitted in light-emitting area 51. Referring to FIG. 18a, light is emitted in all directions, therefore, some of the light will pass directly out of the LED device as shown by light ray 50a, but (some of the light is emitted toward the reflective bus 28). Because the bus 28 is the reflective element in accordance with the present invention, the light is reflected from it back toward the reflective electrode 12 where it may subsequently be re-directed out of the electroluminescent device as illustrated by light ray 50b, or strike the reflective bus 28 a second time. Because both a reflective electrode 12 and bus 18 are formed opposite each other, all emitted light may pass out of the LED device, so that almost no light is lost (except through absorption by imperfectly reflecting surfaces). Hence, the present invention enables an increased fill factor for light-emitting area corresponding to the patterned electrode 16 for the electroluminescent device, since the light emitted from the light-emitting area behind the reflective bus 28 can still escape from the LED device. Referring to FIG. 18b, a top-emitting version of 18a, this embodiment of the present invention includes a reflective electrode 12 located adjacent to the substrate 10 and the electrode 16, on the side of the EL unit 14 opposite the reflective electrode 12 and substrate 10. A transparent insulating layer 33 separates the reflective, electrically-conductive bus 28 from the electrode 16. The layer 33 may be formed using different materials and processes than the corresponding, bottom-emitter insulating layer 32, since the layer 33 will be typically formed over the LED and electrode layers 12, and 16, rather than on the substrate 10. In alternative embodiments of the present invention, referring to FIG. 19, a scattering layer 18 may be optically integrated with the electrodes 12 and 16 respectively and the EL unit 14. As described in co-pending, commonly assigned U.S. Ser. No. 11/065,082, filed Feb. 24, 2005, the disclosure of which is hereby incorporated by reference; light emitted by the organic layers of an OLED may be trapped within the OLED device and a scattering layer may be employed to scatter the trapped light out of the OLED device. As employed herein, a light scattering layer 18 is an optical layer that tends to randomly redirect any light that impinges on the layer from any direction. “Optically integrated” is used herein to indicate that light emitted by the EL unit 14 encounters the scattering layer 22 before traveling through other layers having an optical index lower than those of the materials in the EL unit or electrodes. The scattering layer 18 may be positioned in a variety of locations that are optically coupled to the light-emitting organic material layers 14. For example, the scattering layer 18 may be located between the transparent insulating layer and the transparent electrode 16, as shown in FIG. 19. Alternatively, a scattering layer 18 may be located between the reflective, electrically-conductive bus 28 and the transparent insulating layer (not shown). In another embodiment illustrated in FIG. 20, the surface 40 of a reflective, electrically-conductive bus 28 may itself be light scattering, for example by employing a rough surface. Moreover, a reflective surface of the reflective electrically-conductive bus that is not parallel to one or more of the electrodes may be employed so that fewer reflections may be necessary for light emitted from behind the reflective, electrically-conductive bus 28 to escape from the LED device of the present invention.

It is also useful to improve the contrast of the LED device by reducing ambient reflections from the various components in the device. According to another embodiment of the present invention similar to that shown in FIG. 8, and as illustrated in FIG. 20, the reflective electrically-conductive bus 28 can have a light-absorbing side 42, opposite the electrode 16, in addition to reflective side 40 directed towards the electrode 12.

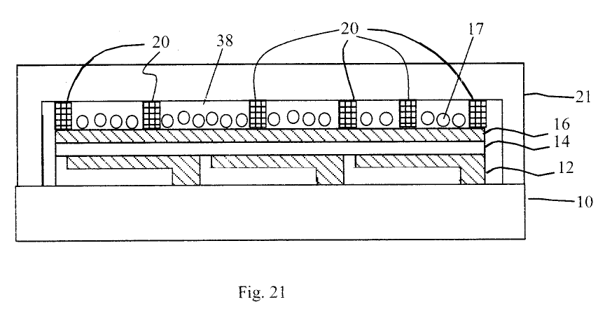

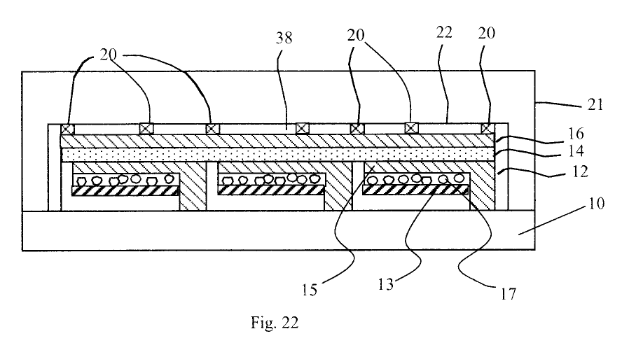

Referring to FIG. 21, in accordance with another top-emitter embodiment of the present invention, an electroluminescent device is shown to have a transparent cover 21 provided over the LED 11, through which light from LED 11 is emitted. A light scattering element 17 is located between the substrate 10 and cover 21 for scattering light emitted by the EL unit 14. Reflective elements 20 are located above the transparent second electrode 16, providing spacing between the transparent second electrode 16 and the cover 21, and forming transparent gaps 38 between the transparent second electrode 16 and the cover 21 within defining openings, the transparent gaps having a third refractive index lower than each of the first refractive index range and second refractive index. One advantage of this embodiment is that additional spacer elements are not needed in the manufacture of the electroluminescent device. In an exemplary embodiment, the reflective elements have a reflective surface 40 and a light absorbing surface 42 as shown in FIG. 8.

According to the present invention reflective elements 20 located above the transparent second electrode 16 provide spacing between the transparent second electrode 16 and the cover 21, and form transparent gaps 38 between the transparent second electrode 16 and the cover 21. The transparent gaps 38 are aligned with the transparent portions 22 of electrode 16 and have a third refractive index lower than each of the first refractive index range and second refractive index.

FIG. 21 illustrates placement of the light-scattering element 17 between the second electrode 16 and cover 21. It is also possible in an alternative embodiment for the first electrode 12 to have multiple layers, for example, including a transparent, electrically conductive layer 15 formed over a reflective layer 13. As shown in FIG. 22, the scattering layer 18 may be located between the reflective layer 13 and the transparent, electrically conductive layer 15. The reflective layer 13 may also be conductive, as may the scattering layer 18. In this case, it is preferred that the transparent, conducting layer 15 have a refractive index in the first refractive index range. In an alternative embodiment of the present invention, the scattering elements 17 may also be reflective (not shown). In an alternative embodiment, the scattering element 18 itself may be an electrode as should be understood from FIG. 20.

In preferred embodiments, the encapsulating cover 21 and substrate 10 may comprise glass or plastic with typical refractive indices of between 1.4 and 1.6. The transparent gaps 38 comprise a solid layer of optically transparent material, a void, or a gap. Voids or gaps may be a vacuum or filled with an optically transparent gas or liquid material. For example air, nitrogen, helium, or argon all have a refractive index of between 1.0 and 1.1 and all may be employed for the present invention. Lower index solids, which may be employed include fluorocarbon or MgF, each having indices less than 1.4. Any gas employed is preferably inert. Reflective first electrode 12 is preferably made of metal (for example aluminum, silver, or magnesium) or metal alloys. Transparent second electrode 16 is preferably made of transparent conductive materials, for example, indium tin oxide (ITO) or other metal oxides. The EL unit 14 may comprise organic or inorganic materials known in the art, for example, hole-injection, hole-transport, light-emitting, electron-injection, and/or electron-transport layers. Such material layers are well known in the OLED and quantum dot art. The material layers typically have a refractive index of between 1.6 and 1.9, while indium tin oxide has a refractive index of approximately 1.8-2.1. Hence, the various layers have a refractive index range of 1.6-2.1. Of course, the refractive indices of various materials may be dependent on the wavelength of light passing through them, so the refractive index values cited here for these materials are only approximate. In any case, the transparent low-index gap preferably has a refractive index at least 0.1 lower than that of each of the first refractive index range and the second refractive index at the desired wavelength for the emitter.

Scattering layer 18 may comprise a volume scattering layer or a surface scattering layer. In certain embodiments, scattering layer 18 may comprise materials having at least two different refractive indices. The scattering layer 18 may comprise, for example a matrix of lower refractive index and scattering elements have a higher refractive index. Alternatively, the matrix may have a higher refractive index and the scattering elements may have a lower refractive index. For example, the matrix may comprise silicon dioxide or cross-linked resin having indices of approximately 1.5, or silicon nitride with a much higher index of refraction. If scattering layer 18 has a thickness greater than one-tenth a part of the wavelength of the emitted light, then it is desirable for the index of refraction of at least one material in the scattering layer 18 to be approximately equal to or greater than the first refractive index range. This is to insure that all of the light trapped in the EL unit 14 and transparent portions 22 of electrode 16 can experience the direction altering effects of scattering layer 18. If scattering layer 18 has a thickness less than one-tenth part of the wavelength of the emitted light, then the materials in the scattering layer need not have such a preference for their refractive indices.

In order to effectively space LED 11 from cover 21 and provide a useful optical structure as discussed above, the reflective element 20 preferably has a thickness of one micron or more, but preferably less than one millimeter. When the scattering element 17 materials are coated above the second electrode layer, the reflective element 20 should preferably have an overall thickness greater than the scattering element 17 in order to provide a gap between the scattering element 17 and the encapsulating cover 21. Since the scattering element 17 preferably has a thickness greater than 500 nm and may be 1 to 2 microns in thickness, the reflective element 20 preferably has an overall thickness of 1 micron or more. The reflective element 20 may be 50 microns in thickness or more, but preferably maintains a thickness of less than 10 microns so as to maximize the sharpness of the device. Conventional lithographic means can be used to create the reflective element 20 using, for example, photo-resist, mask exposures, and etching as known in the art. The reflective element 20 may be deposited using thick film or inkjet techniques. Heat transfer methods, for example, employing lasers, may be employed. The reflective element 20 may, or may not, employ masks to form the grid structure.

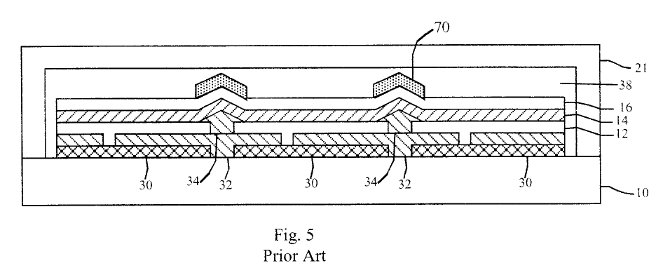

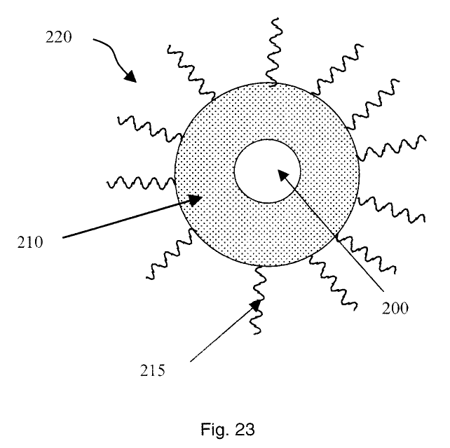

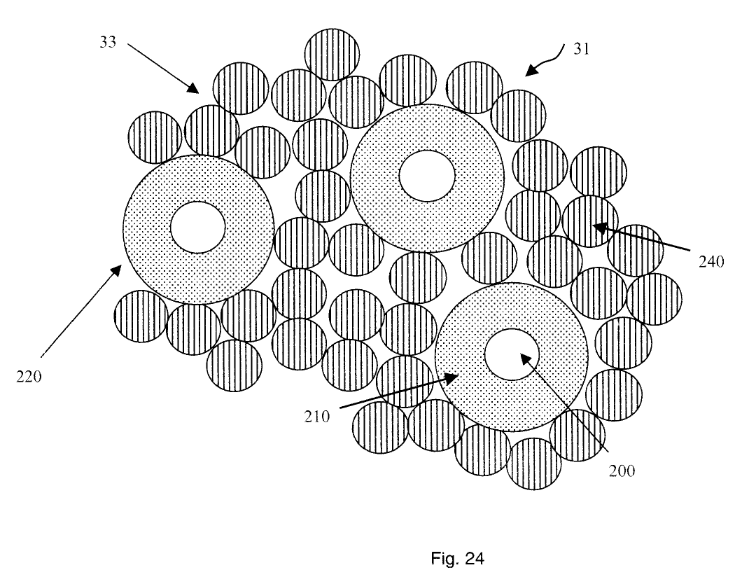

In another embodiment of the present invention employing reflective elements 20 as space elements, the reflective elements 20 may be patterned over the surface of the LED 11 or encapsulating cover 21. Referring to FIG. 5, reflective elements 20 can have a light absorbing surface 42 to increase the sharpness and ambient contrast of the electroluminescent device. The reflective elements 20, in addition to having portions with in the light emitting areas can also have portions around every light emitting area 51 or in areas between some of the light-emitting areas 51. Referring to FIGS. 23 and 24, for one embodiment of the present invention, the light-emissive particles 39 are quantum dots. Using quantum dots as the emitters in light-emitting diodes confers the advantage that the emission wavelength can be simply tuned by varying the size of the quantum dot particle. As such, spectrally narrow (resulting in a larger color gamut), multi-color emission can occur. If the quantum dots are prepared by colloidal methods [and are not grown by high vacuum deposition techniques (S. Nakamura et al., Electronics Letter 34, 2435 (1998))], then the substrate no longer needs to be expensive or lattice matched to the LED semiconductor system. For example, the substrate could be glass, plastic, metal foil, or silicon. Forming quantum dot LEDs using these techniques is highly desirably, especially if low-cost deposition techniques are used to deposit the LED layers.

A schematic of a core/shell quantum dot 220 emitter is shown in FIG. 23. The particle contains a light-emitting core 200, a semiconductor shell 210, and organic ligands 215. Since the size of typical quantum dots is on the order of a few nanometers and commensurate with that of its intrinsic exciton, both the absorption and emission peaks of the particle are blue-shifted relative to bulk values (R. Rossetti et al., Journal of Chemical Physics 79, 1086 (1983)). As a result of the small size of the quantum dots, the surface electronic states of the dots have a large impact on the dot's fluorescence quantum yield. The electronic surface states of the light-emitting core 200 can be passivated either by attaching appropriate (e.g., primary amines) organic ligands 215 to its surface or by epitaxially growing another semiconductor (the semiconductor shell 210) around the light-emitting core 200. The advantages of growing the semiconductor shell 210 (relative to organically passivated cores) are that both the hole and electron core particle surface states can be simultaneously passivated, the resulting quantum yields are typically higher, and the quantum dots are more photostable and chemically robust. Because of the limited thickness of the semiconductor shell 210 (typically 1-2 monolayers), its electronic surface states also need to be passivated. Again, organic ligands 215 are the common choice. Taking the example of a CdSe/ZnS core/shell quantum dot 220, the valence and conduction band offsets at the core/shell interface are such that the resulting potentials act to confine both the holes and electrons to the core region. Since the electrons are typically lighter than the heavy holes, the holes are largely confined to the cores, while the electrons penetrate into the shell and sample its electronic surface states associated with the metal atoms (R. Xie et al., Journal of the American Chemical Society, 127, 7480 (2005)). Accordingly, for the case of CdSe/ZnS core/shell quantum dots 220, only the shell's electron surface states need to be passivated; an example of a suitable organic ligand 215 would be one of the primary amines which forms a donor/acceptor bond to the surface Zn atoms (X. Peng et al., Journal of the American Chemical Society, 119, 7019 (1997)). Typical highly luminescent quantum dots have a core/shell structure (higher bandgap surrounding a lower band gap) and have non-conductive organic ligands 215 attached to the shell's surface.

Colloidal dispersions of highly luminescent core/shell quantum dots have been fabricated by many workers over the past decade (O. Masala and R. Seshadri, Annual Review of Materials Research 34, 41 (2004)). The light-emitting core 200 is composed of type IV (Si), III-V (InAs), or II-VI (CdTe) semiconductive material. For emission in the visible part of the spectrum, CdSe is a preferred core material, since by varying the diameter (1.9 to 6.7 nm) of the CdSe core the emission wavelength can be tuned from 465 to 640 nm. As is well known in the art, visible emitting quantum dots can be fabricated from other material systems, such as, doped ZnS (A. A. Bol et al., Phys. Stat. Sol. B224, 291 (2001)). The light-emitting cores 200 are made by chemical methods well known in the art. Typical synthetic methods include decomposing molecular precursors at high temperatures in coordinating solvents, solvothermal methods (disclosed by O. Masala and R. Seshadri, Annual Review of Materials Research, 34, 41 (2004)), and arrested precipitation (disclosed by R. Rossetti et al., Journal of Chemical Physics, 80, 4464 (1984)). The semiconductor shell 210 is typically composed of type II-VI semiconductive material, such as, CdS or ZnSe. The shell semiconductor is typically chosen to be nearly lattice matched to the core material and have valence and conduction band levels such that the core holes and electrons are largely confined to the core region of the quantum dot. Preferred shell material for CdSe cores is ZnSeₓS₁₋ₓ, with x varying from 0.0 to ˜0.5. Formation of the semiconductor shell 210 surrounding the light emitting core 200 is typically accomplished via the decomposition of molecular precursors at high temperatures in coordinating solvents (M. A. Hines et al., Journal of Physical Chemistry, 100, 468 (1996)) or reverse micelle techniques (A. R. Kortan et al., Journal of the American Chemical Society, 112, 1327 (1990)).

As is well known in the art, two low-cost ways for forming quantum dot films include depositing the colloidal dispersion of core/shell quantum dots 220 by drop casting and spin casting. Alternatively, spray or inkjet deposition may be employed. Common solvents for drop casting quantum dots are a 9:1 mixture of hexane:octane (C. B. Murray et al., Annual Review of Materials Science, 30, 545 (2000)). The organic ligands 215 need to be chosen such that the quantum dot particles are soluble in hexane. As such, organic ligands with hydrocarbon-based tails are good choices, such as, the alkylamines. Using well-known procedures in the art, the ligands coming from the growth procedure (TOPO, for example) can be exchanged for the organic ligand 215 of choice (C. B. Murray et al., Annual Review of Materials Science, 30, 545 (2000)). When depositing a colloidal dispersion of quantum dots, the requirements of the solvent are that it easily spreads on the deposition surface and the solvents evaporate at a moderate rate during the deposition process. It was found that alcohol-based solvents are a good choice; for example, combining a low boiling point alcohol, such as, ethanol, with higher boiling point alcohols, such as, a butanol-hexanol mixture, results in good film formation. Correspondingly, ligand exchange can be used to attach an organic ligand (to the quantum dots) whose tail is soluble in polar solvents; pyridine is an example of a suitable ligand. The quantum dot films resulting from these two deposition processes are luminescent, but non-conductive. The films are resistive, since non-conductive organic ligands separate the core/shell quantum dot 220 particles. The films are also resistive, because as mobile charges propagate along the quantum dots, the mobile charges get trapped in the core regions due to the confining potential barrier of the semiconductor shell 210.

Proper operation of inorganic LEDs typically requires low resistivity n-type and p-type transport layers, surrounding a conductive (nominally doped) and luminescent emitter layer. As discussed above, typical quantum dot films are luminescent, but insulating. FIG. 24 schematically illustrates a way of providing an inorganic light-emitting layer 33 that is simultaneously luminescent and conductive. The concept is based on co-depositing small (<2 nm), conductive inorganic nanoparticles 240 along with the core/shell quantum dots 220 to form the inorganic light-emitting layer 33. A subsequent inert gas (Ar or N₂) anneal step is used to sinter the smaller inorganic nanoparticles 240 amongst themselves and onto the surface of the larger core/shell quantum dots 220. Sintering the inorganic nanoparticles 240, results in fusing the semiconductor nanoparticles into a polycrystalline matrix 31 useful in layer 33 as semiconductor matrix 31. Through the sintering process, the polycrystalline matrix 31 is also connected to the core/shell quantum dots 220. As such, a conductive path is created from the edges of the inorganic light-emitting layer 33, through the semiconductor matrix 31 and to each core/shell quantum dot 220, where electrons and holes recombine in the light emitting cores 200. It should also be noted that encasing the core/shell quantum dots 220 in the conductive polycrystalline semiconductor matrix 31 has the added benefit that it protects the quantum dots environmentally from the effects of both oxygen and moisture.

The inorganic nanoparticles 240 can be composed of conductive semiconductor material, such as, type IV (Si), III-V (GaP), or II-VI (ZnS or ZnSe) semiconductors. In order to easily inject charge into the core/shell quantum dots 220, it is preferred that the inorganic nanoparticles 240 be composed of a semiconductor material with a band gap comparable to that of the semiconductor shell 210 material, more specifically a band gap within 0.2 eV of the shell material's band gap. For the case that ZnS is the outer shell of the core/shell quantum dots 220, then the inorganic nanoparticles 240 are composed of ZnS or ZnSSe with a low Se content. The inorganic nanoparticles 240 are made by chemical methods well known in the art. As is well known in the art, nanometer-sized nanoparticles melt at a much reduced temperature relative to their bulk counterparts (A. N. Goldstein et al., Science 256, 1425 (1992)). Correspondingly, it is desirable that the inorganic nanoparticles 240 have diameters less than 2 nm in order to enhance the sintering process, with a preferred size of 1-1.5 nm. With respect to the larger core/shell quantum dots 220 with ZnS shells, it has been reported that 2.8 nm ZnS particles are relatively stable for anneal temperatures up to 350° C. (S. B. Qadri et al., Physical Review B60, 9191 (1999)). Combining these two results, the annealing process has a preferred temperature between 250 and 300° C. and a duration up to 60 minutes, which sinters the smaller inorganic nanoparticles 240 amongst themselves and onto the surface of the larger core/shell quantum dots 220, whereas the larger core/shell quantum dots 220 remain relatively stable in shape and size.

To form an inorganic polycrystalline light-emitting layer 33, a co-dispersion of inorganic nanoparticles 240 and core/shell quantum dots 220 may be formed. Since it is desirable that the core/shell quantum dots 220 be surrounded by the inorganic nanoparticles 240 in the inorganic polycrystalline light-emitting layer 33, the ratio of inorganic nanoparticles 240 to core/shell quantum dots 220 is chosen to be greater than 1:1. A preferred ratio is 2:1 or 3:1. Depending on the deposition process, such as, spin casting or drop casting, an appropriate choice of organic ligands 215 is made. Typically, the same organic ligands 215 are used for both types of particles. In order to enhance the conductivity (and electron-hole injection process) of the inorganic light emitting layer 33, it is preferred that the organic ligands 215 attached to both the core/shell quantum dots 220 and the inorganic nanoparticles 240 evaporate as a result of annealing the inorganic light emitting layer 33 in an inert atmosphere. By choosing the organic ligands 215 to have a low boiling point, they can be made to evaporate from the film during the annealing process (C. B. Murray et al., Annual Review of Material Science 30, 545 (2000)). Consequently, for films formed by drop casting, shorter chained primary amines, such as, hexylamine are preferred; for films formed by spin casting, pyridine is a preferred ligand. Annealing thin films at elevated temperatures can result in cracking of the films due to thermal expansion mismatches between the film and the substrate. To avoid this problem, it is preferred that the anneal temperature be ramped from 25° C. to the anneal temperature and from the anneal temperature back down to room temperature. A preferred ramp time is on the order of 30 minutes. The thickness of the resulting inorganic polycrystalline light-emitting layer 33 should be between 10 and 100 nm.

Following the annealing step, the core/shell quantum dots 220 would be devoid of organic ligands 215. For the case of CdSe/ZnS quantum dots, having no outer ligand shell would result in a loss of free electrons due to trapping by the shell's unpassivated surface states (R. Xie, Journal of American Chemical Society 127, 7480 (2005)). Consequently, the annealed core/shell quantum dots 220 would show a reduced quantum yield compared to the unannealed dots. To avoid this situation, the ZnS shell thickness needs to be increased to such an extent whereby the core/shell quantum dot electron wavefunction no longer samples the shell's surface states. Using calculational techniques well known in the art (S. A. Ivanov et al., Journal of Physical Chemistry 108, 10625 (2004)), the thickness of the ZnS shell needs to be at least 5 monolayers (ML) thick in order to negate the influence of the electron surface states. However, up to a 2 ML thick shell of ZnS can be directly grown on CdSe without the generation of defects due to the lattice mismatch between the two semiconductor lattices (D. V. Talapin et al., Journal of Physical Chemistry 108, 18826 (2004)). To avoid the lattice defects, an intermediate shell of ZnSe can be grown between the CdSe core and the ZnS outer shell. This approach was taken by Talapin et al. (D. V. Talapin et al., Journal of Physical Chemistry, B108, 18826 (2004)), where they were able to grow up to an 8 ML thick shell of ZnS on a CdSe core, with an optimum ZnSe shell thickness of 1.5 ML. More sophisticated approaches can also be taken to minimize the lattice mismatch difference, for instance, smoothly varying the semiconductor content of the intermediate shell from CdSe to ZnS over the distance of a number of monolayers (R. Xie et al., Journal of the American Chemical Society, 127, 7480 (2005)). In sum, the thickness of the outer shell is made sufficiently thick so that neither free carrier samples the electronic surface states. Additionally, if necessary, intermediate shells of appropriate semiconductor content are added to the quantum dot in order to avoid the generation of defects associated with thick semiconductor shells 210.

As a result of surface plasmon effects (K. B. Kahen, Applied Physics Letter 78, 1649 (2001)), having metal layers adjacent to emitter layers results in a loss in emitter efficiency. Consequently, it is advantageous to space the emitters' layers from any metal contacts by sufficiently thick (at least 150 nm) charge transport layers (e.g. 35, 37) or conductive layers. Finally, not only do transport layers inject electron and holes into the emitter layer, but, by proper choice of materials, they can prevent the leakage of the carriers back out of the emitter layer. For example, if the inorganic nanoparticles 240 were composed of ZnS_{0.5}Se_{0.5} and the transport layers were composed of ZnS, then the electrons and holes would be confined to the emitter layer by the ZnS potential barrier. Suitable materials for the p-type transport layer include II-VI and III-V semiconductors. Typical II-VI semiconductors are ZnSe, ZnS, or ZnTe. Only ZnTe is naturally p-type, while ZnSe and ZnS are n-type. To get sufficiently high p-type conductivity, additional p-type dopants should be added to all three materials. For the case of II-VI p-type transport layers, possible candidate dopants are lithium and nitrogen. For example, it has been shown in the literature that Li₃N can be diffused into ZnSe at ˜350° C. to create p-type ZnSe, with resistivities as low as 0.4 ohm-cm (S. W. Lim, Applied Physics Letters 65, 2437 (1994)).

Suitable materials for n-type transport layers include II-VI and III-V semiconductors. Typical II-VI semiconductors are ZnSe or ZnS. As for p-type transport layers, to get sufficiently high n-type conductivity, additional n-type dopants should be added to the semiconductors. For the case of II-VI n-type transport layers, possible candidate dopants are the Type III dopants of Al, In, or Ga. As is well known in the art, these dopants can be added to the layer either by ion implantation (followed by an anneal) or by a diffusion process (P. J. George et al., Applied Physics Letter 66, 3624 [1995]). A more preferred method is to add the dopant in-situ during the chemical synthesis of the nanoparticle. Taking the example of ZnSe particles formed in a hexadecylamine (HDA)/TOPO coordinating solvent (M. A. Hines et al., Journal of Physical Chemistry B102, 3655 [1998]), the Zn source is diethylzinc in hexane and the Se source is Se powder dissolved in TOP (forming TOPSe). If the ZnSe were to be doped with Al, then a corresponding percentage (a few percent relative to the diethylzinc concentration) of trimethylaluminum in hexane would be added to a syringe containing TOP, TOPSe, and diethylzinc. In-situ doping processes, like these, have been successfully demonstrated when growing thin films by a chemical bath deposition process (J. Lee et al., Thin Solid Films 431-432, 344 [2003]).

The invention has been described in detail with particular reference to certain preferred embodiments thereof, but it will be understood that variations and modifications can be effected within the spirit and scope of the invention.

### PARTS LIST

6 first side
8 second side
10 substrate
11 LED structure
12 electrode
13 reflective layer
14 EL unit
15 transparent electrode
16 electrode
17 scattering elements
18 scattering layer
19 bus
20 reflective portion
21 cover
22 transparent portion
24 patterned reflective conductive layer
26 transparent conductive layer
28 reflective bus
30 thin-film circuitry
31 semiconductor matrix
32 insulator
33 light-emitting layer
34 insulator
35,37 charge transport layers
38 gap
39 quantum dot
40 reflective surface
42 light-absorbing surface
46 color filter
48 low-index element
50, 50b, 50c, emitted light rays
51 light-emitting area
52 ambient light ray
60 reflective edge
70 auxiliary electrode
200 light-emitting core
210 shell
215 organic ligands
220 core/shell quantum dots
240 inorganic conductive nanoparticles

1. An electroluminescent device (EL), comprising:
a first electrode;
a second electrode having a first side and a second side, and wherein at least a portion of the second electrode is transparent;
one or more light-emitting areas that are defined by the first and second electrodes;
an EL unit comprising a light-emitting layer formed between the first electrode and the second electrode, and wherein the first side of the second electrode is adjacent to the EL unit and light that leaves the EL device exits the second side of the second electrode through the transparent portion; and
one or more reflective elements that are electrically-conductive and are formed as part of the second electrode or are in electrical communication with the second electrode; and wherein the reflective elements are located at least partially within the one or more light emitting areas.

2. The electroluminescent device of claim 1, wherein the light-emitting layer is a polycrystalline inorganic light-emitting layer comprising core/shell quantum dots within an inorganic semiconductor matrix.

3. The electroluminescent device of claim 1, wherein the light-emitting layer is a hybrid light-emitting layer comprising core/shell quantum dots within an organic semiconductor matrix.

4. The electroluminescent device of claim 1, wherein the EL unit is comprised of organic materials.

5. The electroluminescent device of claim 1, wherein the second electrode includes multiple non-contiguous transparent portions.

6. The electroluminescent device of claim 1, wherein the reflective elements are thicker than the transparent portion of the second electrode.

7. The electroluminescent device of claim 1, wherein the second electrode comprises a transparent conductive layer and the transparent portion of the second electrode is defined by the reflective elements.

8. The electroluminescent device of claim 1, further comprising a substrate; and a transparent cover provided adjacent to the second side of the second electrode.

9. The electroluminescent device of claim 8 wherein the EL unit and transparent portions of the second electrode have a first refractive index range, and wherein the electroluminescent device further comprises:
a light scattering layer located between the substrate and the cover for scattering light emitted by the light emitting layer, wherein the cover has a second refractive index; and
transparent gaps between the second electrode and the cover, wherein the reflective elements physically space the cover from the second electrode creating said transparent gaps, and wherein the transparent gaps have a third refractive index lower than each of the first refractive index range and the second refractive index.

10. The electroluminescent device of claim 1, further comprising a substrate, wherein the substrate is transparent and is adjacent to the second side of the second electrode.

11. The electroluminescent device of claim 1 further comprising a transparent insulator layer formed adjacent to the second electrode opposite the EL unit and between the second electrode and the reflective elements.

12. The electroluminescent device of claim 11, further comprising a transparent substrate adjacent to the second side of the second electrode, and wherein the first electrode is reflective.

13. The electroluminescent device of claim 11, further comprising a substrate adjacent to a side of the first electrode opposite the EL unit.

14. The electroluminescent device of claim 11, wherein the reflective elements are electrically connected to the second electrode through a via in the transparent insulating layer.

15. The electroluminescent device of claim 7, wherein the transparent conductive layer is continuous and co-extensive with the light-emitting layer.

16. The electroluminescent device of claim 1, further comprising a scattering layer optically integrated with the first and second electrodes and the EL unit.

17. The electroluminescent device of claim 16, wherein the scattering layer is formed only in areas corresponding to the transparent portion of the second electrode.

18. The electroluminescent device of claim 16, wherein at least one of the first and second electrodes is a scattering electrode.

19. The electroluminescent device of claim 1, wherein the transparent portion of the second electrode is equal to or greater than one micron in at least one dimension.

20. The electroluminescent device of claim 1, further comprising color filters located in correspondence with the transparent portion of the second electrode.

21. The electroluminescent device of claim 1, comprising multiple light emitting areas and wherein the transparent portion of the second electrode are not aligned with the light emitting areas.

22. The electroluminescent device of claim 1, further comprising a transistor formed on a substrate and wherein the reflective elements are a conductive bus that is a signal or power bus connected to a terminal of the transistor.

23. The electroluminescent device of claim 1, wherein the reflective elements extend beyond the light-emitting areas.

24. The electroluminescent device of claim 1, wherein the reflective elements have two sides, a first side nearest the EL unit being reflective for reflecting emitted light and a second side opposite the first being light-absorbing for absorbing incident ambient light.
